(19) United States
(12) Patent Application Publication
(10) Pub. No.: US 2018/0113874 A1
(43) Pub. Date: Apr. 26, 2018

(54) INFORMATION PROCESSING APPARATUS, INFORMATION PROCESSING METHOD AND RECORDING MEDIUM WITH INFORMATION PROCESSING PROGRAM

(71) Applicant: FUJITSU LIMITED, Kawasaki-shi (JP)

(72) Inventor: Shinichi Sazawa, Atsugi (JP)

(73) Assignee: FUJITSU LIMITED, Kawasaki-shi (JP)

(21) Appl. No.: 15/849,039

(22) Filed: Dec. 20, 2017

Related U.S. Application Data
(63) Continuation of application No. PCT/JP2015/071865, filed on Jul. 31, 2015.

(51) Int. Cl. G06F 17/30; H04L 1/18; H04L 12/26

(52) U.S. Cl. CPC G06F 17/30097; G06F 17/30017; H04L 67/2842; H04L 43/028; G06F 17/30115; H04L 1/189

(57) ABSTRACT

An information processing apparatus including: a first storage storing identification information for a previously-transmitted object and for data blocks of the object; a second storage storing the data blocks; and a processor performing first processing for performing comparison between a first object to be transmitted and a second object in the second storage, and second processing for extracting a data block from the first object and searching the first storage for the identification information for the extracted data block. The processor, in the first processing, detects an unmatched part between the first object and the second object and transmits position information on a matched part in the second object, and performs second processing for data at a start position of the unmatched part onwards in the first object, and in the second processing, transmits a data block for which no identification information is included in the first storage.

### CROSS-REFERENCE TO RELATED APPLICATION

This application is a continuation application of International Application PCT/JP2015/071865, filed on Jul. 31, 2015, and designated the U.S., the entire contents of which are incorporated herein by reference.

### FIELD

The present invention relates to an information processing apparatus, an information processing method and a recording medium with information processing program.

### BACKGROUND

As one of methods for achieving an increase in speed of communication, there is a method in which an amount of forwarded data is reduced. Examples of the method in which an amount of forwarded data is reduced include a method in which data transmitted in duplicate is removed.

In the method in which data transmitted in duplicate is removed, a transmission-side apparatus and a reception-side apparatus store previously-transmitted or received data in respective caches in advance. If data to be transmitted is stored in the cache, the transmission-side apparatus transmits reference information on the data to be transmitted instead of the data to be transmitted. Upon receipt of the reference information on the data, the reception-side apparatus reads the data relevant to the reference information from the cache and forwards the data to a destination apparatus. Since the reference information on the data to be transmitted is small in size compared to the data to be transmitted, the amount of forwarded data can be reduced, enabling reduction in bandwidth used between the transmission-side apparatus and the reception-side apparatus. Hereinafter, processing and method for removing data transmitted in duplicate are referred to as deduplication processing and method.

FIG. 1 is a diagram illustrating an example of processing for content-defined chunking. Content-defined chunking is an example of deduplication methods. In content-defined chunking, data to be forwarded is divided into variable-length blocks called chunks in first forwarding and the respective chunks are stored in a cache. Also, for each chunk, a hash value is calculated and the hash value and a position at which the chunk is stored are associated with each other. From second forwarding onwards, data to be forwarded is divided into chunks, and a hash value of each chunk is calculated, and the cache is searched for the hash value. If an association between the hash value of the data to be forwarded and a position at which the relevant chunk is stored is found, the hash value is transmitted instead of the chunk of the data to be forwarded. If no association between the hash value of the data to be forwarded and a position at which the relevant chunk is stored, the chunk is transmitted.

Chunks have a size of 1 kilobyte in average. A hash value has a size of, for example, 20 bytes. Therefore, forwarding a hash value instead of a chunk enables reduction in forwarded data amount.

In content-defined chunking, whether or not duplicate data is removed depends on the content of the data to be forwarded. Thus, even if data is partially updated, for a chunk of a non-updated part of the data, a cache can be searched to determine that the chunk is stored, using the relevant hash value, and deduplication can be performed by forwarding the hash value instead of the chunk.

FIG. 2 is a diagram illustrating an example of processing for object-level caching. Object-level caching is one of the deduplication methods. In object-level caching, for example, a file to be forwarded is identified according to a known forwarding protocol, and the file is stored in a cache. A file is an example of objects. In response to an access request for a file stored in a cache, the file stored in the cache is forwarded to the source of the access request.

In the example illustrated in FIG. 2, upon receipt of an access request for object A from a terminal, a proxy server acquires object A from a web server that retains object A, forwards object A to the terminal and stores the object A in a cache thereof. If there is an access request for object A from another terminal, the proxy server transmits object A in the cache to the other terminal.

In object-level caching, where there is an access request for a file stored in a cache, transmission of the file from a web server to a proxy server is omitted. Therefore, as the file is larger in size, the rate of forwarded data reduction is more enhanced.

### PATENT DOCUMENT

[Patent document 1] Japanese Patent Application Domestic Laid-Open Publication No. 2014-508990
[Patent document 2] Japanese Patent Application Domestic Laid-Open Publication No. 2015-502115

However, the conventional deduplication methods have the following problems. Content-defined chunking has the problem of the forwarded data reduction rate having a limit. For example, chunks have a size of 1 kilobyte in average. A hash value has, for example, 20 bytes. In this case, the forwarded data reduction rate is approximately 20 bytes/1 kilobyte, and thus has a limit of approximately 1/50. Also, content-defined chunking has the problem of large load in processing for hash value calculation for chunks and thus large load on a CPU (central processing unit).

In object-level caching, storing is performed in units of objects, that is, on a file-by-file basis in a cache, and thus, there is the problem of, even if just a part of a file is changed, the entire file is forwarded again from an apparatus that retains the original file. For a file that is frequently updated, use of object-level caching causes a failure to perform deduplication, and thus, for example, in file editing or the like in a remote location, forwarded data is not sufficiently reduced.

### SUMMARY

An aspect of the present invention provides an information processing apparatus including a first storage, a second storage and a processor. The first storage is configured to store identification information for a previously-transmitted object and identification information for each of a plurality of data blocks of the previously-transmitted object, the data blocks being separated at respective positions at which a bit string including a predetermined pattern appears, in association with each other. The second storage is configured to store the identification information for the previously-transmitted object and the plurality of data blocks of the previously-transmitted object in association with each other. The processor is configured to perform first processing for performing comparison between data in a first object to be transmitted and data in a second object stored in the second storage, the second object matching identification information for the first object to be transmitted. Also, the processor is configured to perform second processing for sectioning data in the first object to be transmitted off at a position at which the bit string including the predetermined pattern appears to extract a data block, calculating identification information for the extracted data block and searching the first storage for the identification information for the extracted data block. When, in the first processing, an unmatched part between the data in the first object to be transmitted and the data in the second object stored in the second storage is detected and there is a matched part preceding the unmatched part, the processor is configured to transmit at least information on a position of the matched part in the object stored in the second storage. Also, the processor is configured to perform the second processing for data at a start position of the unmatched part onwards in the first object to be transmitted. Also, when, in the second processing, identification information for the extracted data block is not included in the first storage, the processor is configured to transmit the extracted data block, and when identification information for the extracted data block is included in the first storage, the processor is configured to perform the first processing for data in the extracted data block onwards in each of the first object to be transmitted and the second object stored in the second storage.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of processing for content-defined chunking;

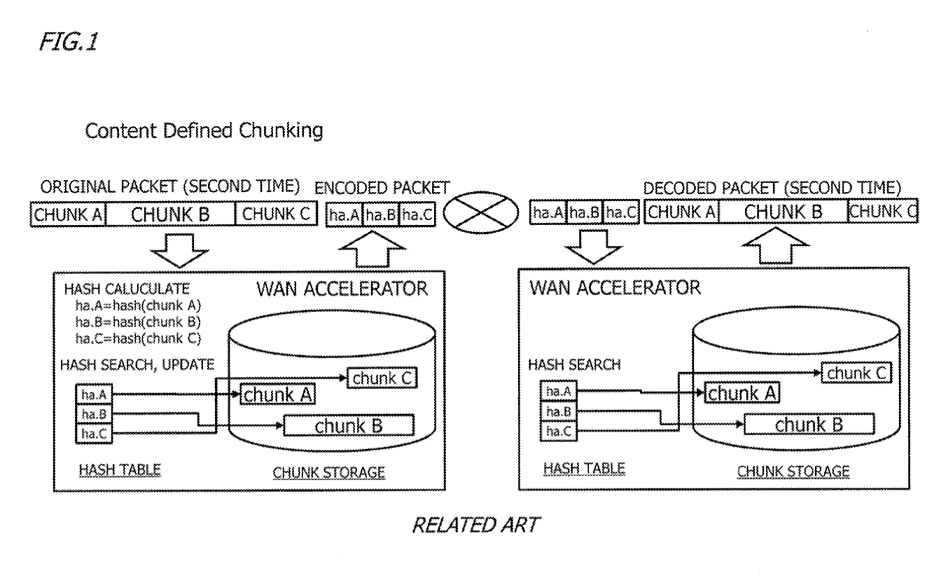

FIG. 2 is a diagram illustrating an example of processing for object-level caching;

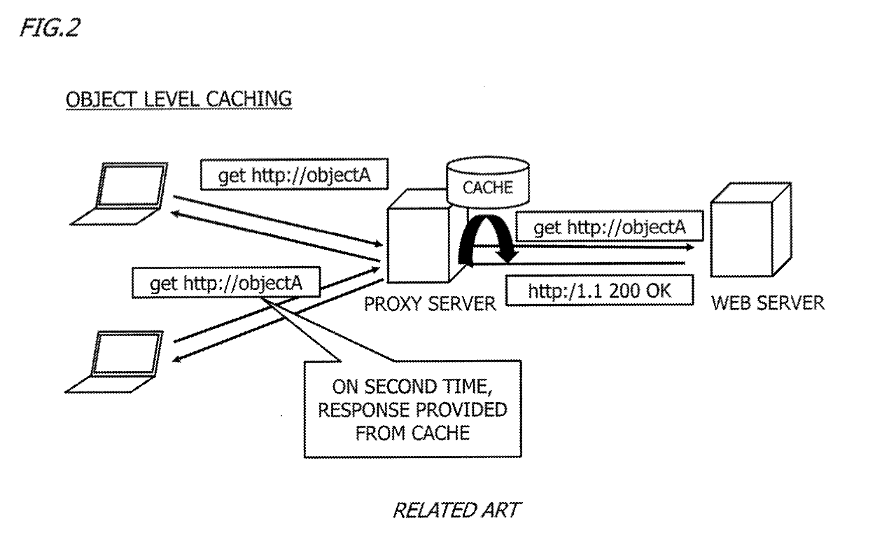

FIG. 3 is a diagram illustrating an example of a method of registration of data to be forwarded in a cache in a first embodiment;

FIG. 4 is a diagram illustrating an example of processing where an object to be transmitted includes an update in the first embodiment;

FIG. 5 is a diagram illustrating an example of a deduplication system according to the first embodiment;

FIG. 6 is a diagram illustrating an example of a hardware configuration of a deduplication apparatus;

FIG. 7 is a diagram illustrating an example of functional components of the deduplication system;

FIG. 8 is a diagram illustrating an example of an inner configuration of a cache in a deduplication apparatus;

FIG. 9 is a diagram illustrating an example of a hash table;

FIG. 10 is a diagram illustrating an example of a data format where a transmission-side deduplication apparatus forwards data to a reception-side deduplication apparatus;

FIG. 11 is a diagram illustrating a diagram illustrating data types;

FIG. 12 is a diagram illustrating an example of a method of division of data into chunks;

FIG. 13 is a diagram illustrating an example of chunk division processing at a tail end of data in a data buffer;

FIG. 14 is a diagram illustrating an example of an overall flow of processing in the transmission-side deduplication apparatus;

FIG. 15 is an example of a flowchart of deduplication processing;

FIG. 16 is an example of a flowchart of object-linked chunk registration processing;

FIG. 17A is an example of a flowchart of object-linked chunk update processing;

FIG. 17B is an example of a flowchart of object-linked chunk update processing;

FIG. 18 is an example of a flowchart for data end processing;

FIG. 19 is a diagram illustrating an example of a flowchart of processing in the reception-side deduplication apparatus;

FIG. 20 is a diagram illustrating a specific example of file overwriting/updating;

FIG. 21 is a diagram illustrating an example of operation and effects of the first embodiment.

### DESCRIPTION OF EMBODIMENT

An embodiment of the present invention will be described below with reference to the drawings. The configuration of the embodiment below is a mere example and the present invention is not limited to the configuration of the embodiment.

### First Embodiment

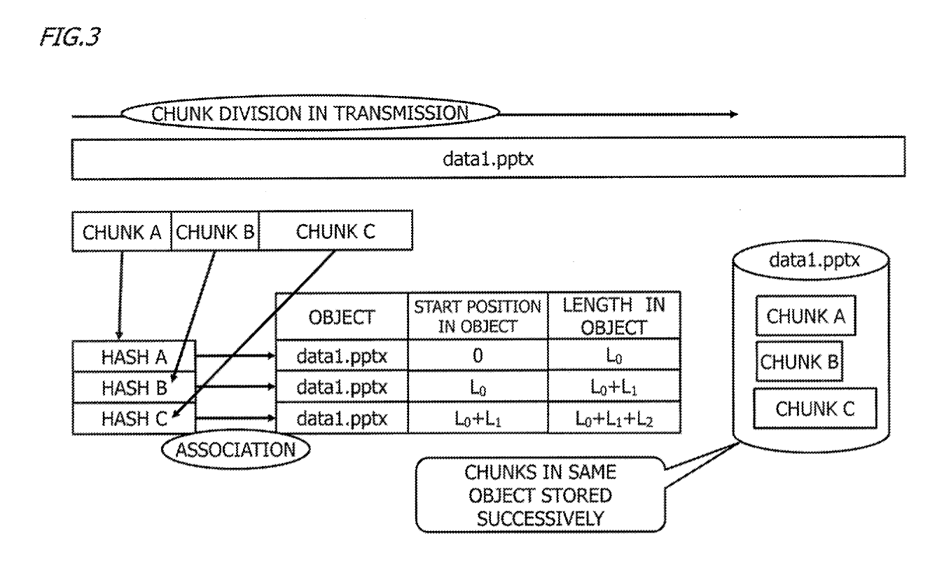

FIG. 3 is a diagram illustrating an example of a method of registration of data to be forwarded in a cache in the first embodiment. In the first embodiment, an object, which is data to be forwarded, is divided into chunks at the time of first forwarding, and the chunks are stored successively in order in a continuous area allocated on an object ID-by-object ID basis in a cache. For each chunk, a hash value is calculated. A hash value of each chunk, an object ID, a start position of the chunk in the object in the cache and a length of the chunk in the object are stored in a hash table in association with one another.

In the first embodiment, a deduplication apparatus that forwards data from a terminal retains a cache for previously-forwarded objects and the hash table. Upon receipt of a request for transmission of an object from a terminal, the deduplication apparatus determines whether or not the object to be transmitted includes an update, and if the object to be transmitted includes no update, the deduplication apparatus does not transmit the object to a destination apparatus, but transmits a response to the source terminal by proxy.

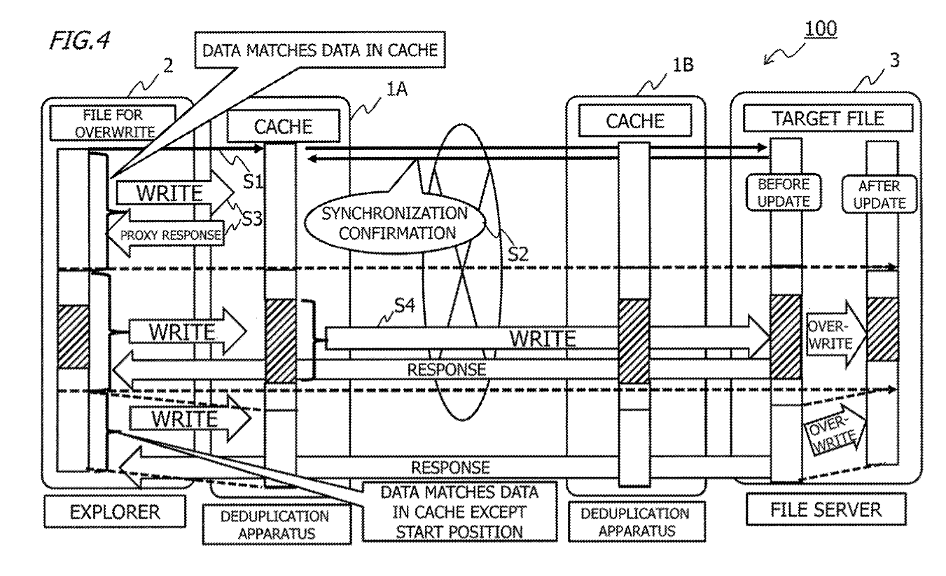

FIG. 4 is a diagram illustrating an example of processing where an object to be transmitted is includes an update in the first embodiment. In the example illustrated in FIG. 4, a source apparatus 2, a transmission-side deduplication apparatus 1A, a reception-side deduplication apparatus 1B and a destination apparatus 3 are extracted. The transmission-side deduplication apparatus 1A and the reception-side deduplication apparatus 1B are positioned so as to be geographically distant from each other, and are connected, for example, via a network such as the Internet. The destination apparatus 3 is, for example, a file server. Hereinafter, the destination apparatus 3 is also referred to as “file server 3”. The source apparatus 2, for example, executes an explorer to remotely access a file on the file server 3 and performs editing of the file.

In the example illustrated in FIG. 4, it is assumed that the source apparatus 2 is accessing a file, the relevant file before an update is previously stored in each of the respective caches of the transmission-side deduplication apparatus 1A and the reception-side deduplication apparatus 1B. Also, it is assumed that the file is partially different from those stored in the respective caches of the transmission-side deduplication apparatus 1A and the reception-side deduplication apparatus 1B as a result of the file being edited and updated by the source apparatus 2.

In S1, for example, upon an operation to overwrite and store a file that is being accessed being performed in the source apparatus 2, a write request for the file is issued from the source apparatus 2 to the transmission-side deduplication apparatus 1A. In S2, for the write-target file, the transmission-side deduplication apparatus 1A confirms that the relevant file stored in the cache thereof and a relevant file in the file server 3 are synchronized.

In S3, since the data (data to be transmitted) transmitted from the source apparatus 2, which is a subject of one write request, matches the data stored in the cache of the transmission-side deduplication apparatus 1A, the transmission-side deduplication apparatus 1A makes a proxy response to the source apparatus 2. In this case, the transmission-side deduplication apparatus 1A does not transmit the relevant data to the file server 3.

In S4, data to be transmitted from the source apparatus 2, which is a subject of one write request, includes an updated part (shaded part in the figure) and does not match the data stored in the cache of the transmission-side deduplication apparatus 1A. In this case, for a chunk including the updated part in the data to be transmitted, which is a subject of one write request, the transmission-side deduplication apparatus 1A transmits actual data of the chunk to the file server 3.

The updated part in S4 is different in size between before and after the update. Thus, in S4, even if the data to be transmitted from the source apparatus 2 and the data stored in the cache of the transmission-side deduplication apparatus 1A match each other in terms of the content in data in the updated part onwards, the data to be transmitted from the source apparatus 2 and the data stored in the cache of the transmission-side deduplication apparatus 1A are different from each other in start position of the matched part in the file. For data in the updated part onwards in which the data to be transmitted from the source apparatus 2 and the data in the cache match each other in content, the transmission-side deduplication apparatus 1A does not transmit the data itself but transmit a cache start position in the file before the data update and a start position in the file after the update. A cache start position is transmitted also for data that is a subject of a write request after S4.

On the other hand, the reception-side deduplication apparatus 1B receives the actual data of the chunk of the updated part, the cache start position of the matched part in the updated part onwards in the file before the update and the start position in the file after the update. The reception-side deduplication apparatus 1B writes the received chunk and data read from the received cache start position in the cache to the respective start positions in the file after the update and forwards the chunk and the data to the file server 3. The file server 3 updates the target file with the chunk including the updated part and the data read from the cache of the reception-side deduplication apparatus 1B, which have been received from the reception-side deduplication apparatus 1B.

For the data in the updated part onwards in which the data to be transmitted from the source apparatus 2 and the data stored in the cache of the transmission-side deduplication apparatus 1A match each other in content, a cache start position of the matched part before the file update is transmitted. That means notification of a position from which the data of the matched part is read in the cache is thus provided to the reception-side deduplication apparatus 1B. Accordingly, even if the updated part has a change in size and the start position of the matched part is shifted, the reception-side deduplication apparatus 1B can read the data of the matched part in the updated part onwards from a proper position in the cache. Consequently, the data of the matched part in the updated part onwards can properly be shifted on the file server 3, enabling maintenance of the consistency of the file between the source apparatus 2 and the file server 3.

Also, at the time of overwriting/updating of a file, many communications are performed between applications; however, according to the first embodiment, in deduplication processing, the consistency of the file between the source apparatus 2 and the file server 3 is maintained, enabling reduction in communications between the applications. Chunks are an example of “data blocks”.

<System Configuration>

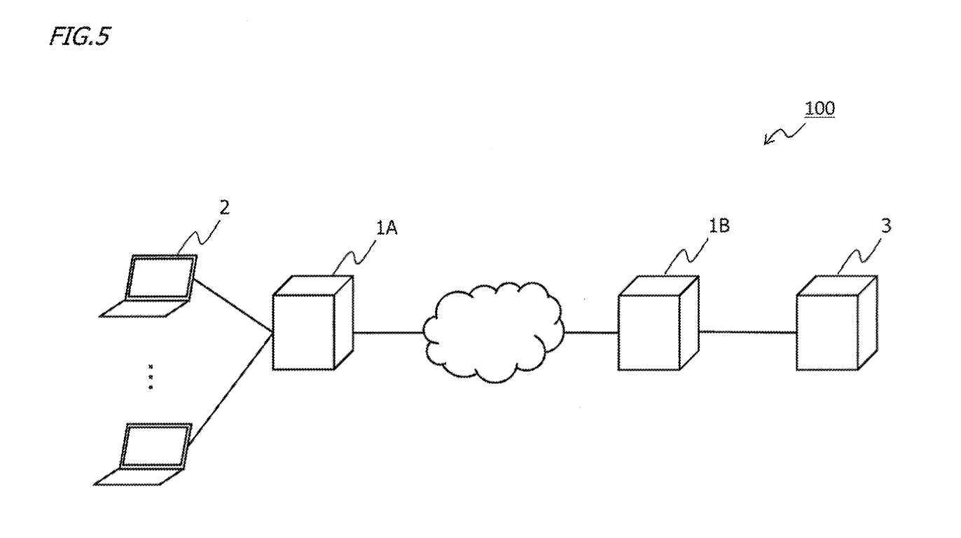

FIG. 5 is a diagram illustrating an example of a deduplication system 100 according to the first embodiment. The deduplication system 100 includes the transmission-side deduplication apparatus 1A, the reception-side deduplication apparatus 1B, the source apparatuses 2 and the destination apparatus 3. The transmission-side deduplication apparatus 1A and the reception-side deduplication apparatus 1B are, for example, apparatuses each located at a boundary between networks and are connected to each other via, e.g., the Internet. The source apparatuses 2 are apparatuses subordinate to the transmission-side deduplication apparatus 1A, and data transmitted/received from/to the source apparatuses 2 are all ones passed through the transmission-side deduplication apparatus 1A. The destination apparatus 3 is an apparatus subordinate to the reception-side deduplication apparatus 1B, and data are transmitted/received from/to the destination apparatus 3 are all ones passed through the reception-side deduplication apparatus 1B.

<Apparatus Configuration>

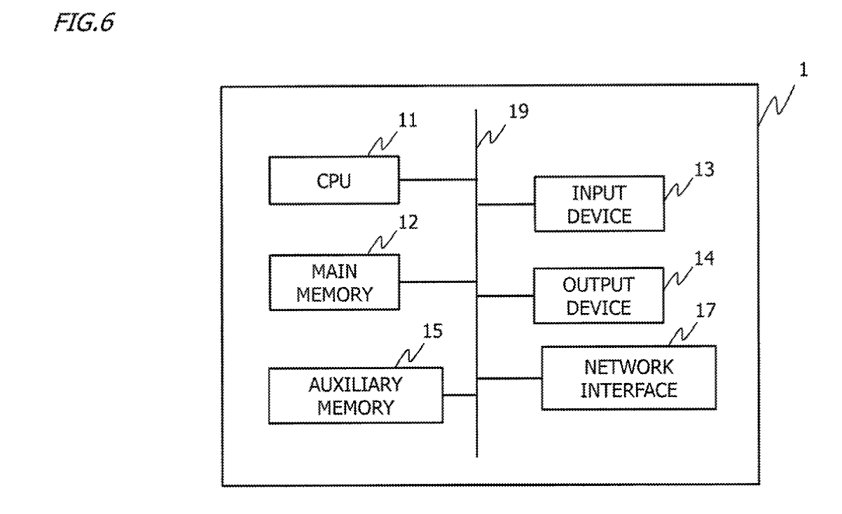

FIG. 6 is a diagram illustrating an example of a hardware configuration of the deduplication apparatus 1. The transmission-side deduplication apparatus 1A and the reception-side deduplication apparatus 1B are apparatuses of a same type, and where the transmission-side deduplication apparatus 1A and the reception-side deduplication apparatus 1B are not distinguished from each other, are collectively referred to as “deduplication apparatuses 1”. The deduplication apparatuses 1 are, for example, dedicated or general-purpose computers.

The deduplication apparatus 1 includes a CPU (central processing unit) 11, a main memory 12, an input device 13, an output device 14, an auxiliary memory 15 and a network interface 17. Also, these components are interconnected via a bus 19.

The input device 13 is, for example, a keyboard, a keypad or the like. Date input from the input device 13 is output to the CPU 11.

The auxiliary memory 15 stores various programs, and data to be used by the CPU 11 in execution of each program. The auxiliary memory 15 is, for example, a non-volatile memory such as an EPROM (erasable programmable ROM), a flash memory or a hard disk drive. The auxiliary memory 15 retains, for example, an operating system (OS), a deduplication program and various other application programs. The deduplication program is a program for deduplication processing of data to be forwarded.

The main memory 12 provides a storage area and a work area in which a program stored in the auxiliary memory 15 is to be loaded, to the CPU 11 and is also used as a buffer or a temporary memory. The main memory 12 includes, for example, a semiconductor memory such as a ROM (read-only memory) or a RAM (random access memory).

The CPU 11 loads the OS and various application programs stored in the auxiliary memory 15 into the main memory 12 and executes the OS and the application programs and thereby performs various processing. The present invention is not limited to the case where a single CPU 11 is provided, and a plurality of CPUs 11 may be provided. The CPU 11 is an example of “processor”.

The network interface 17 is an interface via which information is input/output from/to a network. The network interface 17 includes an interface for connection with a wired network and an interface for connection with a wireless network. The network interface 17 is, for example, a NIC (network interface card) or a wireless LAN (local area network) card. Data or the like received by the network interface 17 is output to the CPU 11.

The output device 14 outputs a result of processing in the CPU 11. The output device 14 includes a display, a printer and/or a sound output device such as a speaker.

Here, the hardware configuration of the deduplication apparatus 1 illustrated in FIG. 6 is a mere example, and the hardware configuration of the deduplication apparatus 1 in the present invention is not limited to the above, and omission, replacement and addition of components are possible as appropriate depending on the embodiment. For example, the deduplication apparatus 1 may include a removable recording medium drive device, and execute a program recorded in a removable recording medium. The removable recording medium is, for example, a recording medium such as an SD card, a miniSD card, a microSD card, a USB (universal serial bus) flash memory, a CD (compact disc), a DVD (digital versatile disc), a Blu-ray (registered trademark) disc or a flash memory card. Also, if the deduplication apparatus 1 is a dedicated server, for example, the deduplication apparatus 1 does not have to include either the input device 13 or the output device 14.

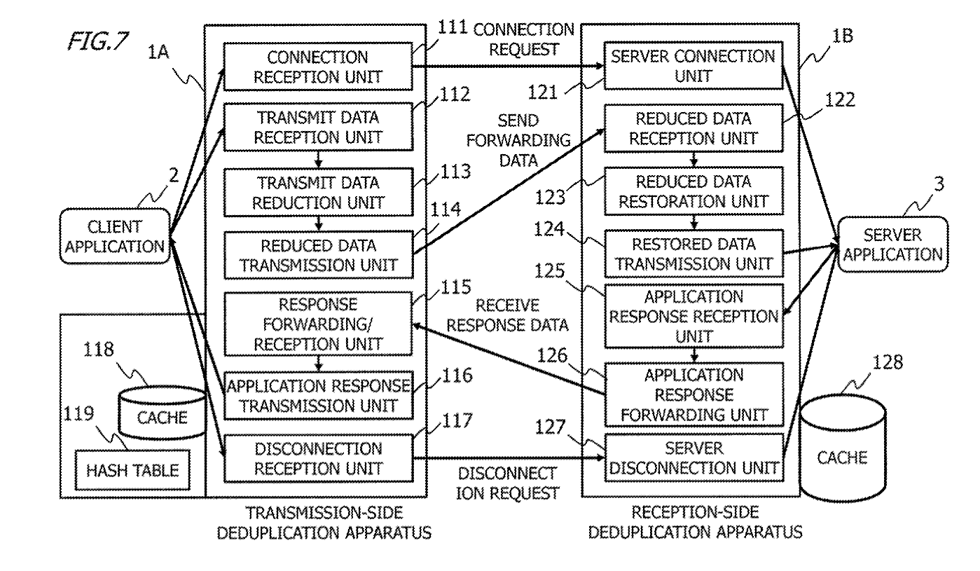

FIG. 7 is a diagram illustrating an example of functional components of the deduplication system 100. The transmission-side deduplication apparatus 1A includes a connection reception unit 111, a transmit data reception unit 112, a transmit data reduction unit 113, a reduced data transmission unit 114, a response forwarding/reception unit 115, an application response transmission unit 116, a disconnection reception unit 117, a cache 118 and a hash table 119, as functional components. These functional components are ones provided by execution of the deduplication program stored in the auxiliary memory 15, by the CPU 11. In FIG. 7, a client application and a server application are illustrated instead of the source apparatus 2 and the destination apparatus 3. Hereinafter, the source apparatus 2 may be referred to as the client application 2. The destination apparatus 3 may be referred to as the server application 3.

The connection reception unit 111 receives a connection request from the client application 2 and forwards the connection request to the server application 3. The transmit data reception unit 112 receives data to be transmitted from the client application 2. The transmit data reception unit 112 includes, for example, a data buffer, and outputs the data to be transmitted accumulated in the data buffer to the transmit data reduction unit 113. The data buffer is provided in a part of the work area of the main memory 12. The data buffer has a size of, for example, 80 kilobytes. However, the size of the data buffer is not limited to this example.

The transmit data reduction unit 113 determines whether or not the data to be transmitted input from the transmit data reception unit 112 includes a duplicate of past forwarded data, and creates alternative information for the duplicate data. The transmit data reduction unit 113 outputs the data to be transmitted including the alternative information, the data being subjected to the duplicate data reduction, to the reduced data transmission unit 114. Details of the alternative information for the duplicate data and details of the processing in the transmit data reduction unit 113 will be described later. The reduced data transmission unit 114 transmits the data to be transmitted, the data being subjected to the duplicate data reduction and input from the transmit data reduction unit 113, to the destination apparatus 3.

The response forwarding/reception unit 115 receives a response to the data transmitted from the reduced data transmission unit 114 from the destination apparatus 3. The response forwarding/reception unit 115 outputs the received response to the application response transmission unit 116. The application response transmission unit 116 forwards the response input from the response forwarding/reception unit 115 to the client application 2.

The disconnection reception unit 117 receives a disconnection request from the client application 2 and forwards the disconnection request to the server application 3. Here, data forwarded from the transmission-side deduplication apparatus 1A to the server application 3 is actually forwarded to the reception-side deduplication apparatus 1B. Hereinafter, forwarding from the transmission-side deduplication apparatus 1A to the server application 3 is also referred to as “transmission to the reception-side deduplication apparatus 1B”, but these expressions mean the same in forwarded data being delivered to the server application 3 via the reception-side deduplication apparatus 1B.

The cache 118 is created in, for example, a storage area of the auxiliary memory 15. Here, the auxiliary memory 15 used for the cache 118 may be incorporated in the transmission-side deduplication apparatus 1A or may be provided externally. In the cache 118, a continuous area is secured for each object ID, and in the continuous area for each object, chunks of the object are stored successively in order. A size of the continuous area secured for each object in the cache 118 may be a size determined in advance or may be set according to the size of the object. The cache 118 is an example of “second storage”.

The hash table 119 is created in, for example, the storage area of the main memory 12. The hash table 119 retains information on chunks stored in the cache. Details of the hash table 119 will be described later. The hash table 119 is an example of “first storage”.

The reception-side deduplication apparatus 1B includes a server connection unit 121, a reduced data reception unit 122, a reduced data restoration unit 123, a restored data transmission unit 124, an application response reception unit 125, an application response forwarding unit 126, a server disconnection unit 127 and a cache 128, as functional components. These components are ones provided by execution of the deduplication program stored in the auxiliary memory 15, by the CPU 11.

The server connection unit 121 receives a connection request from the source apparatus 2 and forwards the connection request to the server application 3. The reduced data reception unit 122 receives forwarded data forwarded by the transmission-side deduplication apparatus 1A. The received data may include alternative information for duplicate data. The reduced data reception unit 122 outputs the received data to the reduced data restoration unit 123.

If the data forwarded by the transmission-side deduplication apparatus 1A includes alternative information for duplicate data, the reduced data restoration unit 123 reads data corresponding to the alternative information from the cache 128 to restore the data. The reduced data restoration unit 123 outputs the received data including the restored data to the restored data transmission unit 124. The restored data transmission unit 124 transmits the data input from the reduced data restoration unit 123 to the server application 3. Also, if the data forwarded by the transmission-side deduplication apparatus 1A includes new data, the reduced data restoration unit 123 stores the new data in the cache 128.

The application response reception unit 125 receives a response from the server application 3 and outputs the response to the application response forwarding unit 126. The application response forwarding unit 126 transmits the response from the server application 3 input from the application response reception unit 125, to the source apparatus 2.

The server disconnection unit 127 receives a disconnection request from the source apparatus 2 and forwards the disconnection request to the server application 3. Here, data received by the reception-side deduplication apparatus 1B from the source apparatus 2 and data transmitted by the reception-side deduplication apparatus 1B to the source apparatus 2 are actually ones transmitted/received via the reception-side deduplication apparatus 1B.

The cache 128 is created in, for example, a storage area of the auxiliary memory 15 in the reception-side deduplication apparatus 1B. Here, the auxiliary memory 15 used for the cache 128 may be incorporated in the reception-side deduplication apparatus 1B or may be provided externally. In the cache 128, as in the cache 118 of the transmission-side deduplication apparatus 1A, a continuous area is secured for each object ID, and in the continuous area for each object, chunks of the object are stored successively in order.

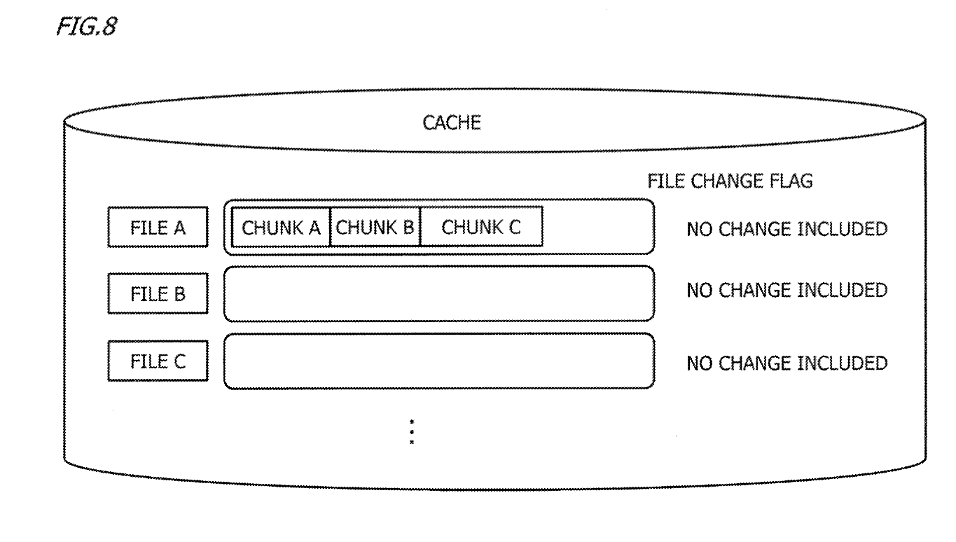

FIG. 8 is a diagram illustrating an example of a data structure of a cache of a deduplication apparatus 1. In the cache, a continuous area is secured for each object, and in the continuous area for each object, chunks of the object are stored. The chunks are stored successively in order.

An area for each object includes a file change flag. The file change flag is a flag indicating whether or not there is a change in a relevant object. For example, if the file change flag is ON (1), it is indicated that the relevant file includes a change. For example, if the file change flag is OFF (0), it is indicated that the relevant file includes no change.

The cache 118 of the transmission-side deduplication apparatus 1A and the cache 128 of the reception-side deduplication apparatus 1B each have such configuration as illustrated in FIG. 8.

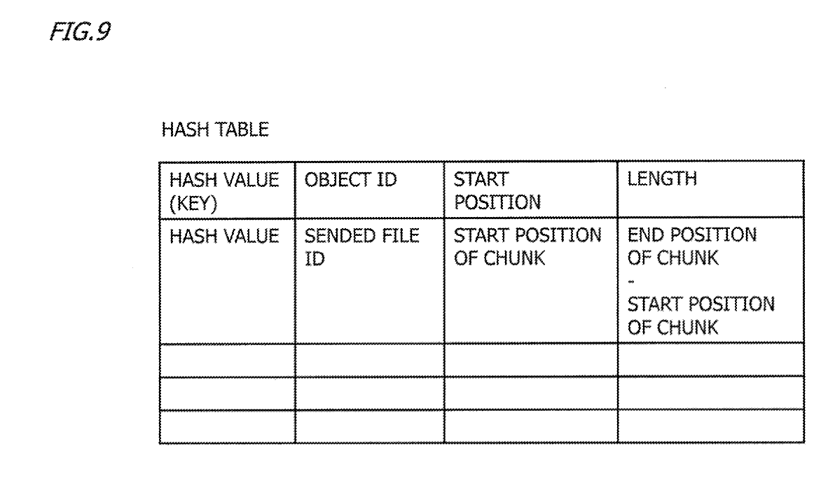

FIG. 9 is a diagram illustrating an example of the hash table 119. In the hash table 119, information on each chunk stored in the cache 118 of the transmission-side deduplication apparatus 1A. More specifically, a hash value, an object ID, a start position and a length are stored as entries in the hash table 119. The hash table 119 is searched using a hash value as a key.

In the “hash value”, for example, a value of around 20 bytes, which is obtained by SHA1 (secure hash algorithm) calculation. A hash value is an example of “identification information for the extracted data block”. In the “object ID”, for example, if an object is a file, a file ID is stored. The file ID may be, for example, a file name.

In the “start position”, a start position of a chunk of an object in the cache 118 is stored in units of bytes. In the “length”, a length of the chunk is stored. The length of the chunk is calculated by subtracting the start position of the chunk from an end position of the chunk of the object in the cache 118.

The hash table 119 is used for, if a mismatch is detected between data to be transmitted, which has been received from the client application 2, and data in the cache 118 of the transmission-side deduplication apparatus 1A, finding a re-start position of a matched part in the mismatched part onwards.

<Transmit/Receive Data Format>

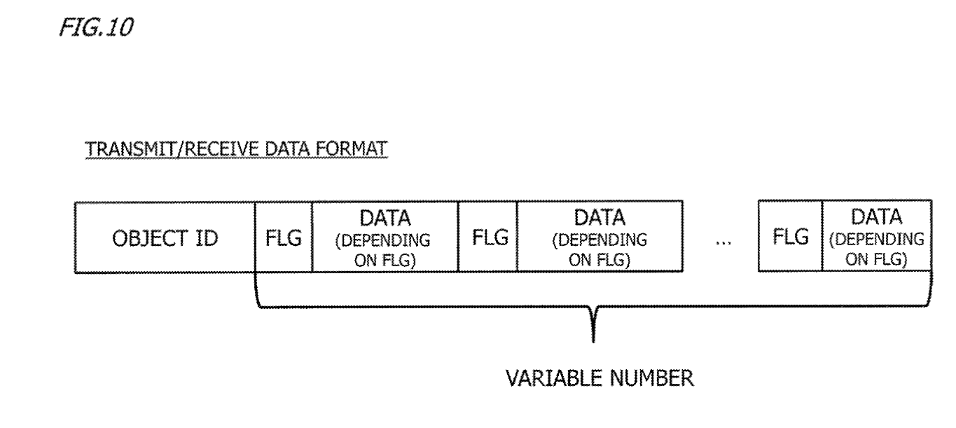

FIG. 10 is a diagram illustrating an example of a data format when the transmission-side deduplication apparatus 1A forwards data to the reception-side deduplication apparatus 1B. In a head of data, an object ID is stored. Subsequently, a plurality of combinations of a flag and a data section (data field) continue. The number of continuous combinations of a flag and a data section is variable.

The transmission-side deduplication apparatus 1A processes data to be transmitted from a client application 2 in units of the data buffer size. The size of the data buffer is, for example, 80 kilobytes. Thus, the data format illustrated in FIG. 10 is created one by one for each data of the data buffer size.

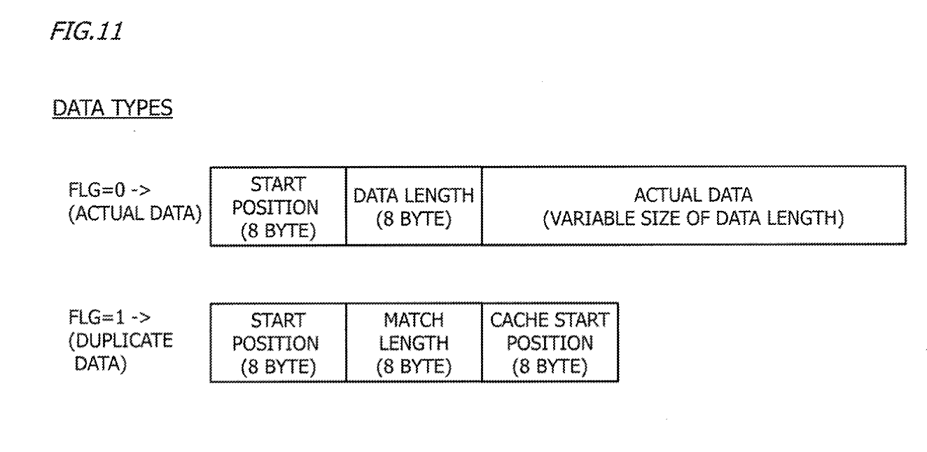

FIG. 11 is a diagram illustrating examples of data types. In FIG. 11, examples of types of the data section included in the data format when the transmission-side deduplication apparatus 1A forwards data to the reception-side deduplication apparatus 1B, which is illustrated in FIG. 10.

If the flag is 0, it is indicated that actual data is stored in the data section. If the flag is 0, a start position of the data in an object, a data length and the actual data are stored in the data section. The start position of the data in the object is a start position of the data in the object to be transmitted, which has been transmitted from the client application 2. A size of a storage field of the start position of the data in the object is fixed as, for example, 8 bytes. A size of a storage field of the data length is fixed as, for example, 8 bytes. A size of a storage field of the actual data can be varied according to the data length of the actual data.

If the flag is 1, it is indicated that information on duplicate data is stored in the data section. In the case where the flag is 1, a start position of data in an object, a match length and a cache start position are included in the data section. The start position of the data in the object is a start position of the duplicate data in the object to be transmitted, which has been transmitted from the client application 2. The match length is a length of a continuous match between data in the object to be transmitted, which has been transmitted from the client application 2, and data in the object stored in the cache 118 of the transmission-side deduplication apparatus 1A. The cache start position is a start position of storage of the duplicate data in the object stored in the cache 118 of the transmission-side deduplication apparatus 1A.

A size of a storage field of each of the start position, the match length and the cache start position in the data section where the flag is 1 is fixed as, for example, 8 bytes.

In the first embodiment, data in the data format illustrated in FIG. 10 is created in units of the data buffer. If the data of the object to be transmitted, which has been transmitted from the client application 2 and stored in the data buffer, fully match the data of the object stored in the cache 118 of the transmission-side deduplication apparatus 1A, no transmit packet in the data format illustrated in FIG. 10 is created. In this case, a proxy response is provided to the client application 2.

If data of from a 20-th kilobyte to a 30-th kilobyte in the data stored in the data buffer is updated and the updated part changes in size from 20 kilobytes before the update to 10 kilobytes after the update, the data format is changed as follows. It is assumed that the data buffer size is 80 kilobytes.
object ID
flag (1), start position (X), match length (20 kilobytes), cache start position (X)
flag (0), start position (X+20 kilobytes), data length (10 kilobytes), actual data
flag (1), start position (X+30 kilobytes), match length (50 kilobytes), cache start position (X+40 kilobytes)

The cache start position in the third flag-data section combination is a start position of storage of duplicate data in the object in the cache 118, and thus, is X+20 kilobytes (first match length)+20 kilobytes (size of the data of the updated part before the update). Consequently, the reception-side deduplication apparatus 1B can properly read non-updated data following the updated part from a position of the cache start position X+40 kilobytes in the cache 128.

<Method of Division of Data into Chunks>

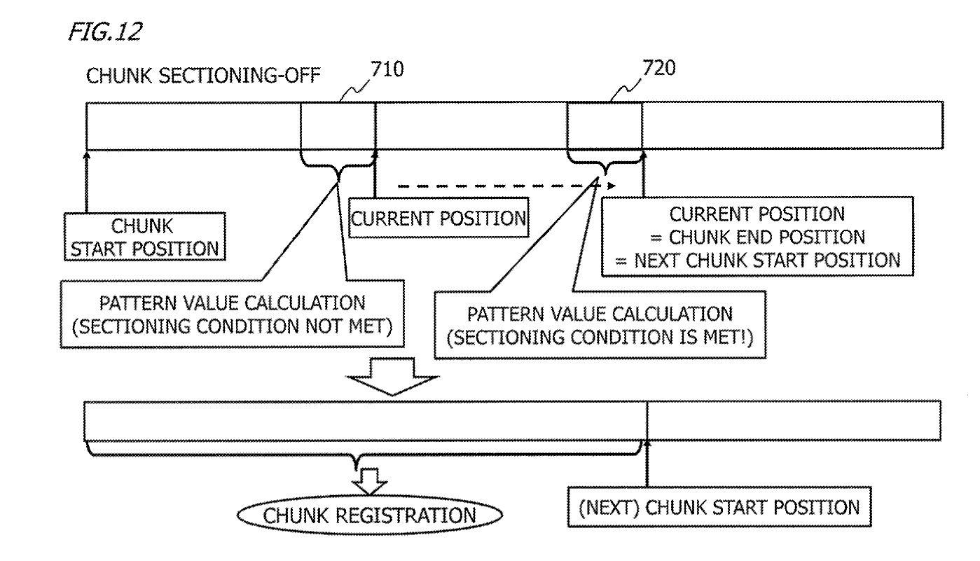

FIG. 12 is a diagram illustrating an example of a method of division of data into chunks. Chunks are created by determining whether or not data read from a data buffer matches a bit pattern according to a disconnection condition while shifting the area in the data. The bit pattern according to the disconnection condition is, for example, a predetermined pattern that appears in a bit string with a probability of 1/1024. Upon appearance of a bit string matching the bit pattern according to the disconnection condition, the data is sectioned off at a tail end of the bit string into a chunk.

In the example illustrated in FIG. 12, a bit pattern of partial data 710 in the data buffer does not match the bit pattern according to the disconnection condition, and thus, the partial data 710 is not sectioned off into a chunk at the current position that is a tail end of the partial data 710. Since a bit pattern of partial data 720 in the data buffer matches the bit pattern according to the disconnection condition, and thus, the partial data 720 is sectioned off into a chunk at the current position that is a tail end of the partial data 720. A head of the data illustrated in FIG. 12 to the tail end of the partial data 720 is registered as one chunk. An end position of the chunk is a start position of a next chunk. However, where the positions are expressed in bytes, the start position of the next chunk is the end position of the chunk plus 1 byte.

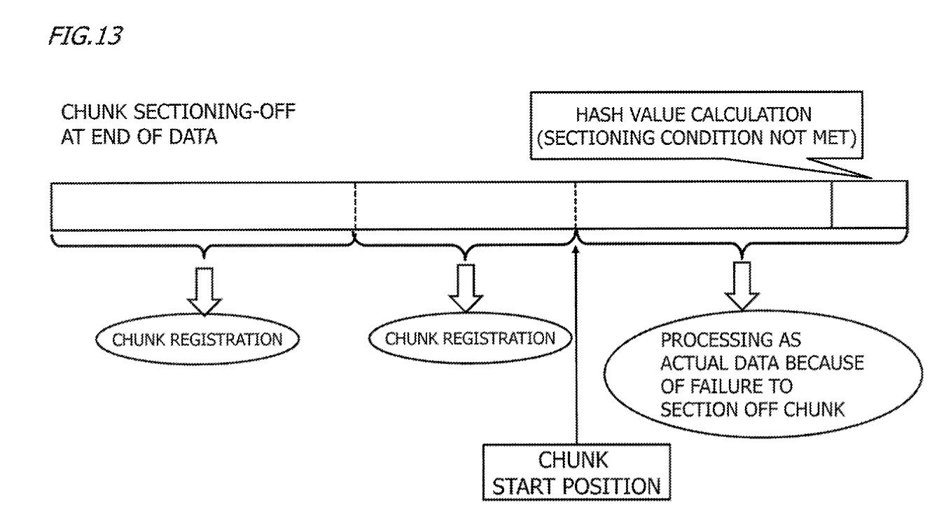

FIG. 13 is a diagram illustrating an example of chunk division processing at a tail end of data in a data buffer. If a bit string of a tail end of data in a data buffer does not match a bit pattern according to a disconnection condition, data of from an end position of a last chunk to the tail end of the data in the data buffer is registered in the cache as actual data. The relevant part is not a chunk and thus is not registered in the hash table 119.

<Flow of Processing>

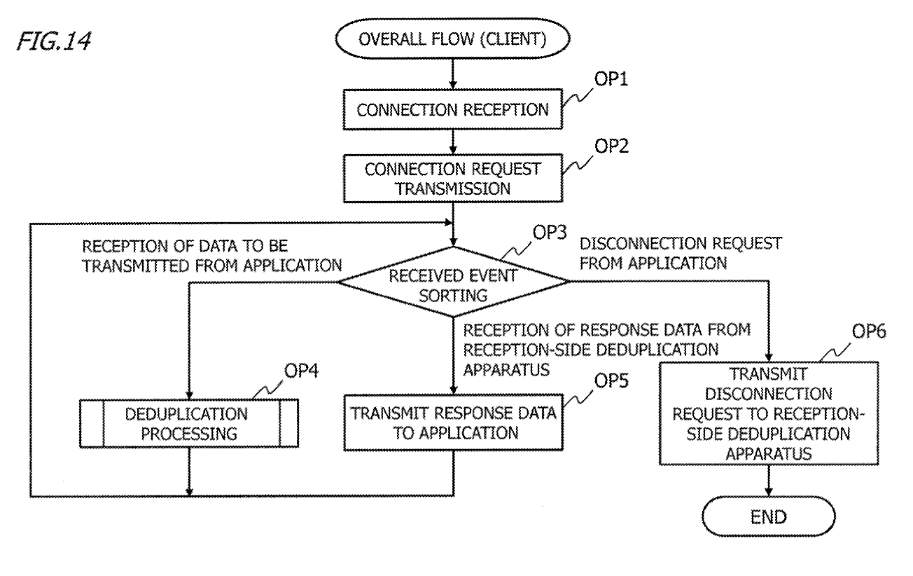

FIG. 14 is a diagram illustrating an overall flow of processing in the transmission-side deduplication apparatus 1A. The processing illustrated in FIG. 14 is started upon start of the transmission-side deduplication apparatus 1A. Although an entity that executes the processing illustrated in FIG. 14 is the CPU 11, description will be provided with functional components provided by execution of the deduplication program by the CPU 11 as the entities for respective operations in the processing.

In OP1, the connection reception unit 111 receives a connection request from a client application 2. In OP2, the connection reception unit 111 forwards the received connection request to the server application 3. The connection request is delivered to the reception-side deduplication apparatus 1B and forwarded to the server application 3 by the reception-side deduplication apparatus 1B.

In OP3, a received event is sorted. If the event is reception of data to be transmitted from the client application 2, the processing proceeds to OP4. If the event is reception of response data from the reception-side deduplication apparatus 1B, the processing proceeds to OP5. If the event is a disconnection request from the client application 2, the processing proceeds to OP6.

In OP4, deduplication processing is performed for the data to be transmitted received from the client application 2. Details of the deduplication processing will be described later. Upon end of the deduplication processing, the processing proceeds to OP3.

In OP5, the response forwarding/reception unit 115 outputs the response data from the reception-side deduplication apparatus 1B to the application response transmission unit 116, and the application response transmission unit 116 forwards the response data to the client application 2. Subsequently, the processing proceeds to OP3.

In OP6, the disconnection reception unit 117 forwards the disconnection request received from the client application 2, to the reception-side deduplication apparatus 1B. Subsequently, the processing illustrated in FIG. 14 ends.

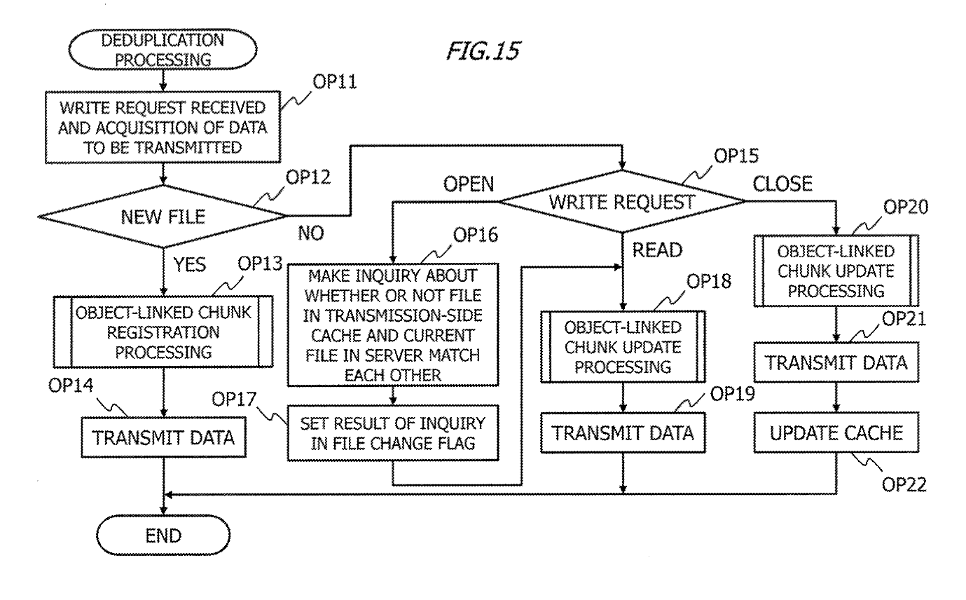

FIG. 15 is an example of a flowchart of deduplication processing. The flowchart illustrated in FIG. 15 is started upon receipt of a write request from the client application 2. Although an entity that executes the processing illustrated in FIG. 15 is the CPU 11, for convenience, description will be provided with the transmit data reduction unit 113 as the entity.

In OP11, the transmit data reduction unit 113 acquires data to be transmitted accumulated in the data buffer, the data to be transmitted being a subject of the write request, from the transmit data reception unit 112.

In OP12, the transmit data reduction unit 113 determines whether or not a file including the data to be transmitted that is the subject of the write request is a new file. Hereinafter, a file including data that is a subject of a write request is simply referred to as a “write request-subject file”. For example, if an object ID of the write request-subject file and the data are stored in the cache 118 in association with each other, the write request-subject file is determined as not a new file. For example, if the object ID of the write request-subject file and the data are not stored in the cache 118 in association with each other, the write request-subject file is determined as a new file. The object ID of the file is, for example, a file name. The file name is included in the write request.

If the write request-target file is a new file (OP12: YES), the processing proceeds to OP13. If the write request-target file is not a new file (OP12: NO), the processing proceeds to OP15.

In OP13, the transmit data reduction unit 113 performs object-linked chunk registration processing, which is processing for registering the new file in the cache 118. Details of the object-linked chunk registration processing will be described later.

In OP14, the transmit data reduction unit 113 outputs the data to be transmitted that is the subject of the write request to the reduced data transmission unit 114. The data to be transmitted is forwarded to the reception-side deduplication apparatus 1B by the reduced data transmission unit 114. Subsequently, the processing illustrated in FIG. 15 ends.

In OP15, the transmit data reduction unit 113 determines a message included in the write request. Examples of the message included in the write request include “OPEN” indicating a start of the file, “READ” indicating data partway of the file, and “CLOSE” indicating an end of the file. If the message included in the write request is “OPEN”, the processing proceeds to OP16. If the message included in the write request is “READ”, the processing proceeds to OP18. If the message included in the write request is “CLOSE”, the processing proceeds to OP20.

In OP16, the transmit data reduction unit 113 makes an inquiry about whether or not data stored in the cache 118 and data retained by the server application 3 match each other, for the write request-subject file.

In OP17, the transmit data reduction unit 113 sets a result of the inquiry in OP16 in a file change flag. For the write request-subject file, the file change flag is set to a value indicating either “no change included” or “change included”, according to whether or not the data stored in the cache 118 and the data retained by the server application 3 match each other.

In OP18 or OP20, the transmit data reduction unit 113 performs object-linked chunk update processing, which is processing for generating information for updating the data stored in the server application 3. In the object-linked chunk update processing, for example, a transmit packet in the format illustrated in FIG. 10 is created. Details of the object-linked chunk update processing will be described later.

In OP19 or OP21, the transmit data reduction unit 113 transmits the transmit packet created in OP18 or OP20 to the reception-side deduplication apparatus 1B. After the processing in OP19, the processing illustrated in FIG. 15 ends.

In OP22, if the write request-subject file in the cache 118 includes an update, the transmit data reduction unit 113 updates the file in the cache 118. Subsequently, the processing illustrated in FIG. 15 ends.

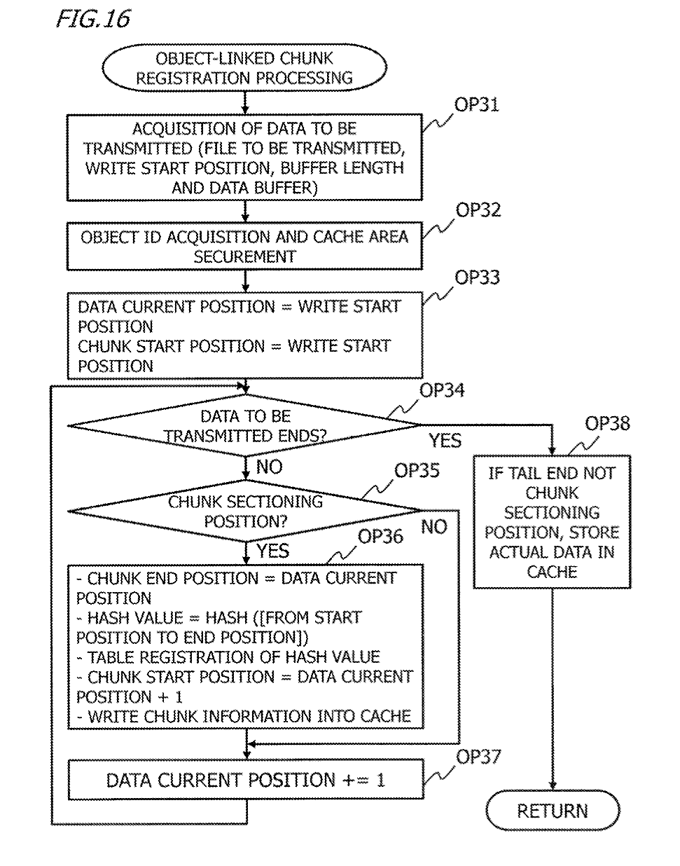

FIG. 16 is an example of a flowchart of object-linked chunk registration processing. The object-lined chunk registration processing is processing for registering data of a new file in a cache. Although an entity that executes the processing illustrated in FIG. 16 is the CPU 11, for convenience, description will be provided with the transmit data reduction unit 113 as the entity.

In OP31, the transmit data reduction unit 113 acquires data to be transmitted in the data buffer. Here, the transmit data reduction unit 113 acquires a file name of a file including the data to be transmitted, a write start position of the data to be transmitted in the file including the data to be transmitted, a length of the data buffer, and the data to be transmitted in the data buffer.

In OP32, the transmit data reduction unit 113 acquires an object ID and secures an area corresponding to the object ID in the cache 118. The secured area in the cache 118 may be an area secured so as to have a size uniformly set for any object ID, and may be an area secured by acquiring a size of a file and setting a size of the area to be larger than the size of the file.

In OP33, the transmit data reduction unit 113 sets a data current position to the write start position and a chunk start position to the write start position. The data current position is a parameter indicating a position currently referred to in the file including the data to be transmitted. The chunk start position is a start position of a chunk in the file including the data to be transmitted.

In OP34, the transmit data reduction unit 113 determines whether or not the data to be transmitted ends. If the data to be transmitted ends (OP34: YES), the processing proceeds to OP38. If the data to be transmitted does not end (OP34: NO), the processing proceeds to OP35.

In OP35, the transmit data reduction unit 113 determines whether or not the data current position is a chunk sectioning position. This processing is performed by determining whether or not a bit string of a predetermined bit length, the bit string preceding the data current position by a predetermined bit, matches a bit pattern according to a disconnection condition (see FIG. 12). If the data current position is a chunk sectioning position (OP35: YES), the processing proceeds to OP36. If the data current position is not a chunk sectioning position (OP35: NO), the processing proceeds to OP37.

In OP36, the transmit data reduction unit 113 performs the following. The transmit data reduction unit 113 sets a chunk end position as the data current position. The transmit data reduction unit 113 calculates a hash value for a part from the chunk start position to the chunk end position, and registers the calculated hash value in the hash table 119. In the hash table 119, an object ID, the chunk start position and a length of the chunk are also registered in addition to the hash value. The transmit data reduction unit 113 updates the chunk start position to the data current position plus 1 byte. The transmit data reduction unit 113 writes the chunk into the cache 118.

In OP37, the transmit data reduction unit 113 adds one byte to the data current position to update the data current position. Next, the processing proceeds to OP34.

In OP38, since the data to be transmitted in the data buffer ends, if a tail end of the data to be transmitted is not a chunk sectioning position, the transmit data reduction unit 113 writes actual data of from an end position of a last chunk to the tail end into the cache 118. Subsequently, the processing illustrated in FIG. 16 ends.

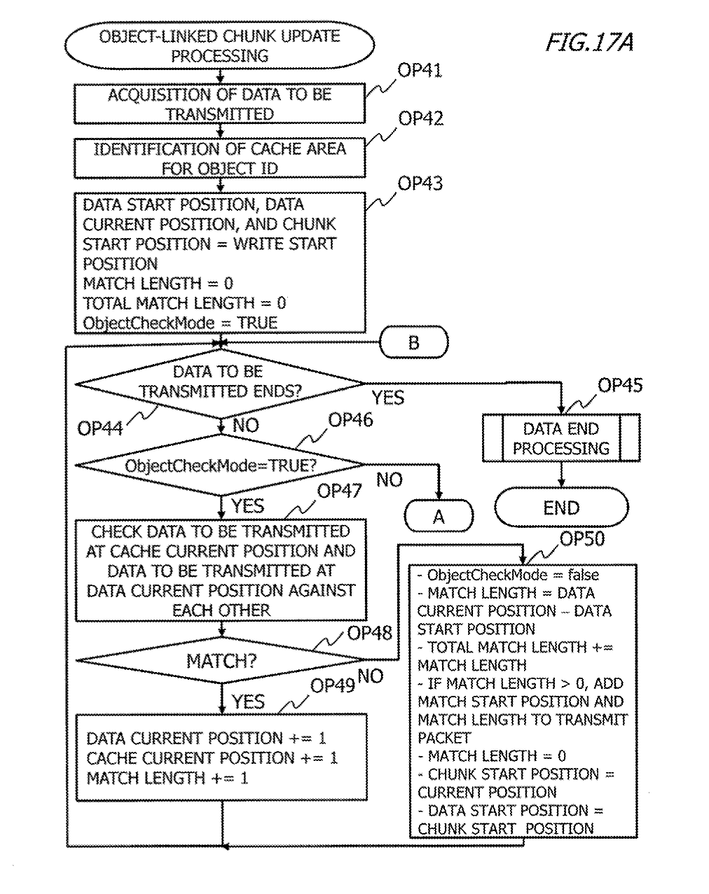

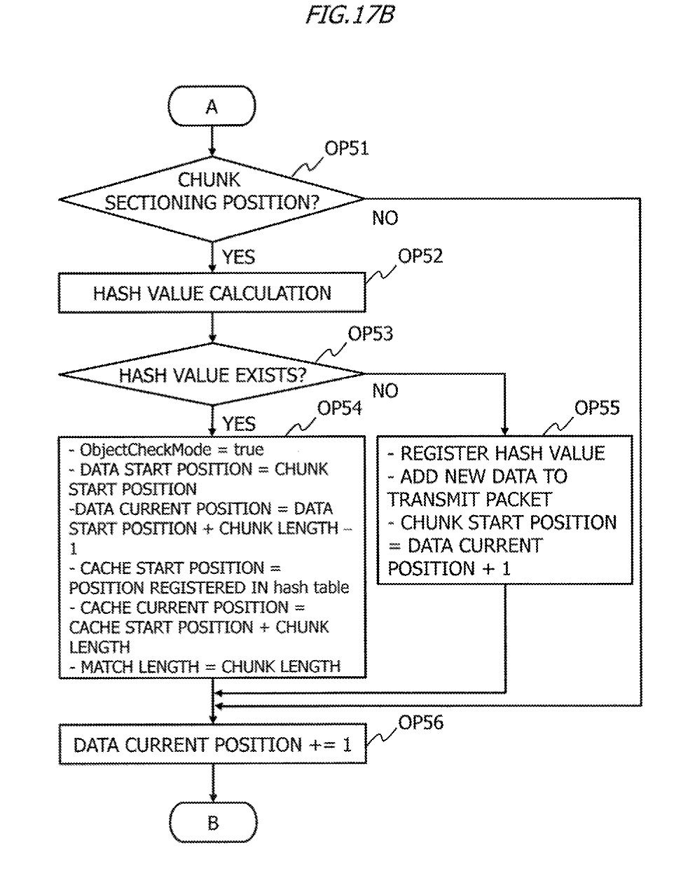

FIGS. 17A and 17B provide an example of a flowchart of object-linked chunk update processing. Object-linked chunk update processing is processing for generating information for updating data stored in the server application 3. Although an entity that executes the processing illustrated in FIGS. 17A and 17B is the CPU 11, for convenience, description will be provided with the transmit data reduction unit 113 as the entity.

In OP41, the transmit data reduction unit 113 acquires data to be transmitted in the data buffer. Here, the transmit data reduction unit 113 acquires a file name of a file including the data to be transmitted, a write start position of the data to be transmitted in the file including the data to be transmitted, a length of the data buffer, and the data to be transmitted in the data buffer.

In OP42, the transmit data reduction unit 113 acquires an object ID and identifies an area corresponding to the object ID in the cache 118.

In OP43, the transmit data reduction unit 113 sets a data start position, a data current position and a chunk start position to the write start position. The transmit data reduction unit 113 sets a match length to 0. The transmit data reduction unit 113 sets a total match lengths to 0. The transmit data reduction unit 113 sets an ObjectCheckMode to true. Also, the cache current position is a parameter indicating a position currently referred to in the relevant file in the cache 118, and if the write start position for the data to be transmitted is 0, is set to 0, and subsequently, a value at the time of end of processing for last data to be transmitted for the same file is taken over and used. In OP43, the cache start position is set to the cache current position.

The match length is a parameter indicating a length of a continuous match between the data to be transmitted and the data in the cache 118. The total match length is a parameter indicating a total sum of lengths of matches between the data to be transmitted and the data in the cache 118.

The ObjectCheckMode indicates a method of checking the data to be transmitted. If the ObjectCheckMode is true, simple memory comparison between the data to be transmitted and the data in the cache 118 is performed. If the ObjectCheckMode is false, processing for dividing the data to be transmitted into chunks, calculating a hash value of each chunk and searching the hash table 119 for the hash value is performed. The processing where the ObjectCheckMode is true is an example of “first processing”. The processing where the ObjectCheckMode is false is an example of “second processing”.

In OP44, the transmit data reduction unit 113 determines whether or not the processing for the data to be transmitted ends. If the processing for the data to be transmitted ends (OP44: YES), the processing proceeds to OP45. If the processing for the data to be transmitted does not end (OP44: NO), the processing proceeds to OP46.

In OP45, since the processing for the data to be transmitted ends, data end processing is performed. Details of the data end processing will be described later. After completion of the data end processing, the processing illustrated in FIG. 17A ends.

In OP46, the transmit data reduction unit 113 determines whether or not the ObjectCheckMode is true. If the ObjectCheckMode is true (OP46: YES), the processing proceeds to OP47. If the ObjectCheckMode is false, the processing proceeds to OP51.

The processing in OP47 to OP50 is processing where the ObjectCheckMode is true. In OP47, the transmit data reduction unit 113 checks data at the cache current position in the cache 118 and data at the data current position in the data to be transmitted against each other.

In OP48, the transmit data reduction unit 113 determines whether or not the data at the cache current position in the cache 118 and the data at the data current position in the data to be transmitted match each other. If the data at the cache current position in the cache 118 and the data at the data current position in the data to be transmitted match each other (OP48: YES), the processing proceeds to OP49. If the data at the cache current position in the cache 118 and the data at the data current position in the data to be transmitted do not match each other (OP48: NO), the processing proceeds to OP50.

In OP49, since the data at the cache current position in the cache 118 and the data at the data current position in the data to be transmitted match each other, the transmit data reduction unit 113 increments respective values of the data current position, the cache current position, the match length and the total match length by one byte to update the values. Next, the processing proceeds to OP44.

In OP50, the transmit data reduction unit 113 sets the ObjectCheckMode to false. The transmit data reduction unit 113 updates the match length to a value resulting from subtraction of the data start position from the data current position. If the match length is larger than 0, the transmit data reduction unit 113 adds a match start position in the data to be transmitted (start position) and a match start position in the data in the cache 118 (cache start position), and the updated match length to a data section with a flag of 1 in a transmit packet. Next, the transmit data reduction unit 113 sets the match length to 0. The transmit data reduction unit 113 sets the chunk start position to the data current position. The transmit data reduction unit 113 sets the data start position to the chunk start position. Next, the processing proceeds to OP44.

The processing in OP51 to OP56 in FIG. 17B is processing where the ObjectCheckMode is false. In OP51, the transmit data reduction unit 113 determines whether or not the data current position in the data to be transmitted is a chunk sectioning position. If the data current position in the data to be transmitted is a chunk sectioning position (OP51: YES), the processing proceeds to OP52. If the data current position in the data to be transmitted is not a chunk sectioning position (OP51: NO), the processing proceeds to OP56.

In OP52, the transmit data reduction unit 113 calculates a hash value for the data of from the chunk start position to the data current position. In OP53, the transmit data reduction unit 113 determines whether or not the calculated hash value exists in the hash table 119.

If the calculated hash value exists in the hash table 119 (OP53: YES), the processing proceeds to OP54. If the calculated hash value does not exist in the hash table 119 (OP53: NO), the processing proceeds to OP55.

In OP54, the transmit data reduction unit 113 sets the ObjectCheckMode to true. The transmit data reduction unit 113 updates the data start position to a chunk start position. The data current position corresponds to a value resulting from decrement of a value that is a sum of the updated data start position and a chunk length by 1 byte. The transmit data reduction unit 113 updates the cache start position to a cache start position in the relevant entry in the hash table. The transmit data reduction unit 113 updates the cache current position to a value resulting from addition of the chunk length to the cache start position. The transmit data reduction unit 113 updates the match length to the chunk length.

In OP55, the transmit data reduction unit 113 registers the calculated hash value in the hash table 119. The transmit data reduction unit 113 adds new data of from the chunk start position to the data current position to a data section with a flag of 0 in a transmit packet. The transmit data reduction unit 113 updates the chunk start position to a value resulting from increment of the data current position by 1 byte.

In OP56, the transmit data reduction unit 113 increments the data current position by 1 byte to update the data current position. Subsequently, the processing proceeds to OP44.

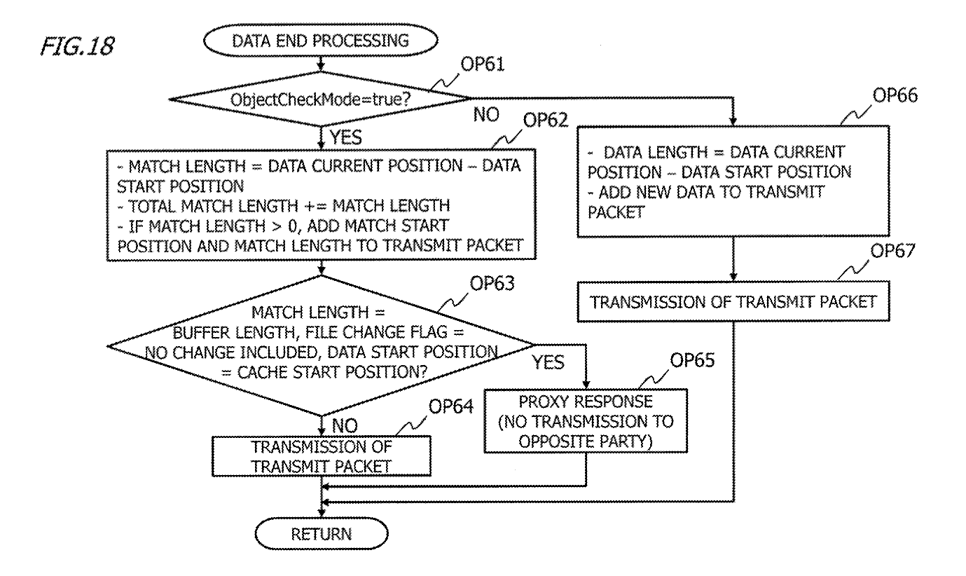

FIG. 18 is an example of a flowchart of data end processing. The data end processing is processing where processing for the data to be transmitted ends.

In OP61, the transmit data reduction unit 113 determines whether or not the ObjectCheckMode is true. If the ObjectCheckMode is true (OP61: YES), the processing proceeds to OP62. If the ObjectCheckMode is false (OP61: NO), the processing proceeds to OP66.

OP62 to OP65 indicate processing where the ObjectCheckMode is true, that is, where a tail end of the data to be transmitted and data in the cache 118 match each other. In OP62, the transmit data reduction unit 113 updates the match length to a value resulting from subtraction of the data start position from the data current position. The transmit data reduction unit 113 updates the total match length to a value resulting from addition of the updated match length. If the match length is larger than 0, the transmit data reduction unit 113 adds a position of the data from which the match starts in the data to be transmitted and the position of the data from which the match starts in the cache 118, and the updated match length to a data section with a flag of 1 in the transmit packet.

In OP63, the transmit data reduction unit 113 determines whether or not the match length and the data buffer length correspond to each other and the file change flag indicates that no change is included and the data start position is the cache start position. As result of the determination, whether or not the data to be transmitted in the data buffer and the data in the cache 118 fully match each other and the subject file includes an update is determined. If the above conditions are met (OP63: YES), the processing proceeds to OP65. If the above conditions are not met (OP63: NO), the processing proceeds to OP64.

In OP64, since the above conditions are not met, the data to be transmitted in the data buffer and the data in the cache 118 do not fully match each other or even though the data to be transmitted in the data buffer and the data in the cache 118 fully match each other, the respective start positions are made not to correspond to each other by the update of the file. Thus, the transmit data reduction unit 113 transmits the transmit packet. Subsequently, the processing illustrated in FIG. 18 ends.

In OP65, since the above conditions are met, the data to be transmitted in the data buffer and the data in the cache 118 fully match each other, and the respective start positions also correspond to each other, the transmit data reduction unit 113 makes a proxy response to the client application 2. Here, the data is not transmitted to the server application 3. Subsequently, the processing illustrated in FIG. 18 ends.

The processing in OP66 and OP67 is processing where the ObjectCheckMode is false. In OP66, the transmit data reduction unit 113 sets a data length in a data section with a flag of 0 to a value resulting from subtraction of the data start position from the data current position and adds new data of from the chunk start position to the tail end of data to the data section.

In OP67, the transmit data reduction unit 113 transmits the transmit packet. Subsequently, the processing illustrated in FIG. 18 ends.

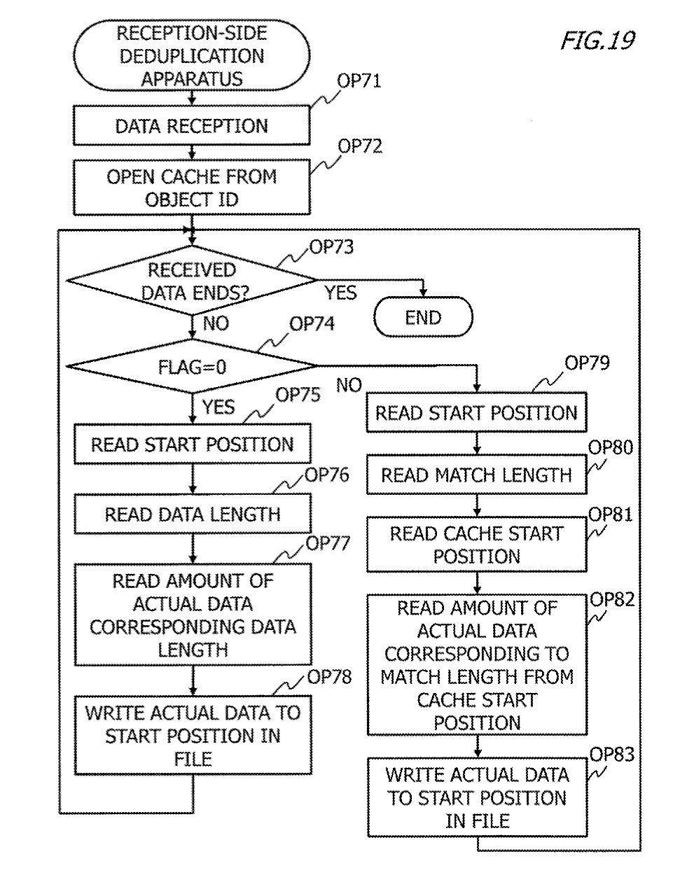

FIG. 19 is a diagram illustrating an example of a flowchart of processing in the reception-side deduplication apparatus 1B. The processing illustrated in FIG. 19 is started upon start of the reception-side deduplication apparatus 1B and is repeatedly performed during operation. Although an entity that performs the processing illustrated in FIG. 19 is the CPU 11, for convenience, description will be provided with the reduced data restoration unit 123 as the entity.

In OP71, the reduced data restoration unit 123 receives data from the transmission-side deduplication apparatus 1A through the reduced data reception unit 122. In OP72, the reduced data restoration unit 123 identifies an area in the cache 128 from an object ID in the data.

In OP73, the reduced data restoration unit 123 determines whether or not the received data ends. If the received data ends (OP73: YES), the processing illustrated in FIG. 19 ends. If the received data does not end (OP73: NO), the processing proceeds to OP74.

In OP74, whether or not the reduced data restoration unit 123 determines whether or not a flag is 0. If the flag is 0 (OP74: YES), the processing proceeds to OP75. If the flag is 1 (OP74: NO), the processing proceeds to OP79.

OP75 to OP78 indicate processing where the flag is 0, that is, actual data is included in a data section. In OP75, the reduced data restoration unit 123 reads a start position in the data section. In OP76, the reduced data restoration unit 123 reads a data length in the data section. In OP77, the reduced data restoration unit 123 reads an amount of the actual data, the amount corresponding to the data length, in the data section.

In OP78, the reduced data restoration unit 123 writes the read actual data into the read start position in a relevant file in a temporary memory area in the main memory 12. Next, the processing proceeds to OP73.

The processing in OP79 to OP83 is processing where the flag is 1, that is, where the data is duplicate data. In OP79, the reduced data restoration unit 123 reads a start position in the data section. In OP80, the reduced data restoration unit 123 reads a match length in the data section. In OP81, the reduced data restoration unit 123 reads a cache start position in the data section.

In OP82, the reduced data restoration unit 123 reads an amount of actual data, the amount corresponding to the match length read from the data section of the received data, from the cache start position read from the data section of the received data, in the cache 128. In OP83, the reduced data restoration unit 123 writes the read actual data into the start position read from the data section of the received data, in the relevant file in the temporary memory area in the main memory 12. Next, the processing proceeds to OP73.

Also, if the file ends, an area for the relevant object ID in the cache 128 is overwritten with the data written in the temporary memory area and the data is thus stored. Also, the data written in the temporary memory area is transmitted from the reception-side deduplication apparatus 1B to the server application 3, and the relevant file in the server application 3 is overwritten and updated.

### Specific Example

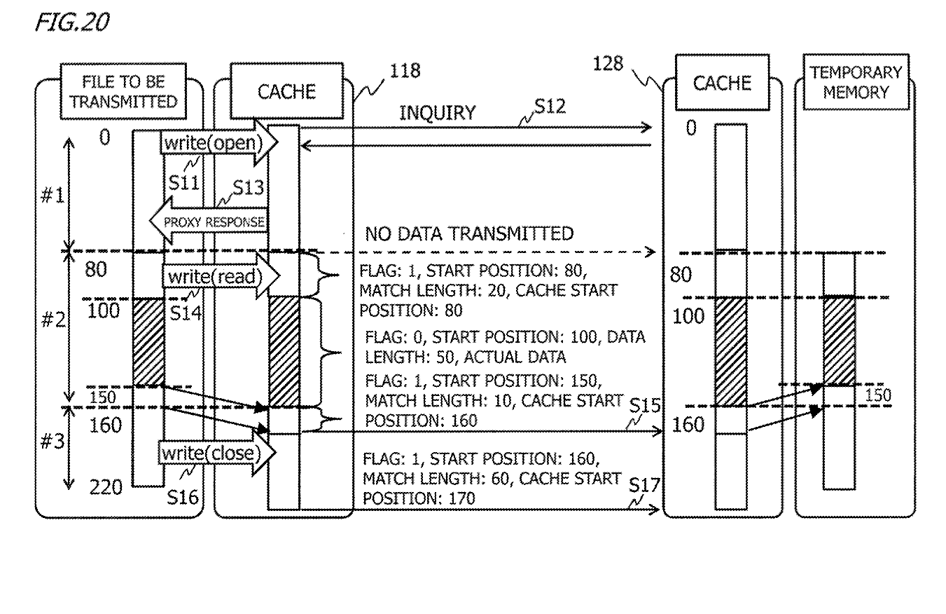

FIG. 20 is a diagram illustrating a specific example of file overwriting/updating. In FIG. 20, an example where a request for overwriting/updating file A is transmitted from a client application is indicated. An updated part of file A is indicated by shading. As the “file to be transmitted” in FIG. 20, data transmitted from a client application and stored in the data buffer of the transmission-side deduplication apparatus 1A is illustrated. In FIG. 20, it is assumed that the data buffer has a size of 80 kilobytes. Each of data #1, data #2 and data #3 is data stored in the data buffer, which is data that may be a subject of one write request.

File A is stored in a state before an update in each of the cache 118 of the transmission-side deduplication apparatus 1A and the cache 128 of the reception-side deduplication apparatus 1B. In the example illustrated in FIG. 20, it is assumed that a connection between the client application 2 and the server application 3 is already established.

In S11, the transmit data reduction unit 113 receives a write request including the message “OPEN” from the client application 2 (FIG. 15, OP11, OP12: NO, OP15).

In S12, the transmit data reduction unit 113 makes an inquiry about whether or not file A in the cache 118 and file A retained by the server application 3 match each other, to the server application 3 (FIG. 15, OP16). In FIG. 20, the server application 3 is omitted. The transmit data reduction unit 113 sets a result of the inquiry in a file change flag (FIG. 15, OP17). In FIG. 20, file A in the cache 118 and file A retained by the server application 3 match each other, and thus, the file change flag is set as “no change included”.

Since data to be transmitted #1 include no updated part and the data to be transmitted and the data in the cache 118 match each other, the processing in OP46 to OP49 in FIG. 17A is repeated. At the time of a data end of data #1, the ObjectCheckMode is true (FIG. 18, OP61: YES). A match length is 80 kilobytes and thus corresponds to the size of the data buffer. The file change flag indicates no change included. A data start position and a cache start position are both 0 bytes and thus correspond to each other (FIG. 18, OP63: YES).

Therefore, in S13, the transmit data reduction unit 113 makes a proxy response to the client application 2, and transmits no data to the reception-side deduplication apparatus 1B (FIG. 18, OP65).

In S14, the transmit data reduction unit 113 receives a write request including the message “READ” from the client application 2 (FIG. 15, OP11, OP12: NO, OP15).

Since a write start position for data to be transmitted #2 is 80 kilobytes, the data start position is 80 kilobytes. The cache start position for data to be transmitted #2 is a cache current position at the time of the end of the processing for data to be transmitted #1 and thus 80 kilobytes. Data #2 includes an updated part. Since a part from an 80-th kilobyte to a 99999-th byte of the file including data to be transmitted #2 is not updated, the processing in OP46 to OP49 in FIG. 17A is repeated.

A part from a 100-th kilobyte to a 149999-th byte of the file including data to be transmitted #2 is the updated part. In comparison with the 100-th kilobyte of the file including data to be transmitted #2 and a 100-th kilobyte of file A in the cache 118 (FIG. 17A, OP47), respective data do no match each other (FIG. 17A, OP48: NO).

Here, a data section with a flag of 1 in which a start position of 80 kilobytes, a match length of 20 kilobytes (data current position of 100 kilobytes—data start position of 80 kilobytes) are stored is added to a transmit packet (FIG. 17A, OP50). The ObjectCheckMode is set to false. A chunk start position is set to 100 kilobytes, which is the data current position.

Since the part of the 100-th kilobyte to the 149999-th byte of the file including data to be transmitted #2 is the updated part, the processing in OP46: NO in FIG. 17A and OP51 to OP53 and OP55 to OP56 in FIG. 17B is repeated.

In processing for the 149999-th byte, which is a tail end of the updated part, the chunk start position is set to 150 kilobytes resulting from increment of the data current position by 1 byte (FIG. 17B, OP55). Also, a data section with a flag of 0 including a start position of 100 kilobytes, a chunk length of 50 kilobytes and actual data of from the 100-th kilobyte to the 149999-th byte of the file including data to be transmitted #2 is added to the transmit packet.

For a part from a 150-th kilobyte of the file including data to be transmitted #2, data in the file including data to be transmitted #2 and data in file A in the cache 118 match each other. Thus, a hash value calculated for a first chunk sectioning position in the 150-th kilobyte onwards of the file including data to be transmitted #2 (FIG. 17B, OP51: YES) exists in the hash table 119 (FIG. 17B, OP53: YES). It is assumed that a cache start position of 160 kilobytes is registered as an entry for the relevant chunk in the hash table 119.

Here, the ObjectCheckMode is set to true. The data start position is set to 150 kilobytes, which is the chunk start position. The cache start position is set to 160 kilobytes, which is a cache position of the calculated hash value in the hash table 119. A match length is set to a chunk length, that is, a length from the 150-th kilobyte to the chunk sectioning position of the file to be transmitted.

For a part up to the 160-th kilobyte of the file including data to be transmitted #2, the ObjectCheckMode is true (FIG. 17A, OP46: YES), and data in the file including data to be transmitted #2 and data in file A in the cache 118 match each other, and thus, the processing in OP47 to OP49 in FIG. 17A is repeated.

When the data current position reaches 160 kilobytes, the processing for data to be transmitted #2 ends (FIG. 17A, OP44: YES), and the data end processing in FIG. 18 is performed. A match length is 10 kilobytes resulting from subtraction of the data start position of 150 kilobytes from the data current position of 160 kilobytes. A total match length is 30 kilobytes resulting from addition of the match length of 10 kilobytes to 20 kilobytes. Also, a data section with a flag of 1 in which the start position is 150 kilobytes, the match length is 10 kilobytes and the cache start position is 160 kilobytes is added to the transmit packet (FIG. 18, OP62).

In S15, the processing for data to be transmitted #2, which is a subject of one write request, ends, and thus, the transmit packet is transmitted to the reception-side deduplication apparatus 1B. The content of the transmit packet is as follows.
Object ID (file A)
Flag (1), start position (80 kilobytes), match length (20 kilobytes), cache start position (80 kilobytes)
Flag (0), start position (100 kilobytes), data length (50 kilobytes), actual data
Flag (1), start position (150 kilobytes), match length (10 kilobytes), cache start position (160 kilobytes)

The reception-side deduplication apparatus 1B receives the packet having the above content and writes the data of file A into the temporary memory. First, according to the data section with the flag (1), the start position (80 kilobytes), the match length (20 kilobytes) and the cache start position (80 kilobytes), data of 20-kilobytes is read from 80 kilobytes in file A in the cache 128 and is written into a position of 80 kilobytes in the data in the temporary memory (FIG. 19, OP79 to OP83).

Next, according to the data section with the flag (0), the start position (100 kilobytes), the data length (50 kilobytes) and the actual data, the 50-kilobyte actual data is written into a position of a 100-th kilobyte in the temporary memory (FIG. 19, OP75 to OP78).

According to the data section with the flag (1), the start position (150 kilobytes), the match length (10 kilobytes) and the cache start position (160 kilobytes), data of 10 kilobytes is read from a 160-th kilobyte of file A in the cache 128 and is written into a position of 150 kilobytes in the temporary memory (FIG. 19, OP79 to OP83).

In S16, the transmit data reduction unit 113 receives a write request including the message “CLOSE” from the client application 2 (FIG. 15, OP11, OP12: NO, OP15).

Data to be transmitted #3, which is a subject of a write request, includes no updated part. A write start position for data to be transmitted #3 is 160 kilobytes. At the point of start of processing for data to be transmitted #3, the data current position is 160 kilobytes, a match length and a total match length are 0 and the ObjectCheckMode is true. Also, the cache start position is a cache current position of 170 kilobytes at the point of time of the end of the processing for the data to be transmitted #2.

Data from the 160-th kilobyte to a 220-th kilobyte of the file including data to be transmitted #3 matches data in the cache 118, and thus, the processing in OP46 to OP49 in FIG. 17A is repeated. At the time of data end of data to be transmitted #3, the ObjectCheckMode is true (FIG. 18, OP61: YES). The match length and the total match length are 60 kilobytes, which do not correspond to the size of the data buffer. A file change flag indicates “no change included”. The data start position of 160 kilobytes and the cache start position of 170 kilobytes do not correspond to each other (FIG. 18, OP63: NO).

Thus, in S17, the transmit data reduction unit 113 transmits a transmit packet including a data section with a flag of 1 in which the start position is 160 kilobytes, the match length is 60 kilobytes and the cache start position is 170 kilobytes is transmitted (FIG. 18, OP64).

The reception-side deduplication apparatus 1B receives the packet including the data section with the flag (1), the start position (160 kilobytes), the match length (60 kilobytes) and the cache start position (170 kilobytes). According to the packet, data of 60 kilobytes is read from 170 kilobytes in file A in the cache 128 and written into a position of the 160 kilobytes in the data in the temporary memory (FIG. 19, OP79 to OP83).

The reception-side deduplication apparatus 1B transmits the data in the temporary memory to the server application 3. The server application 3 updates data in a 80-th kilobyte onwards of file A with the data received from the reception-side deduplication apparatus 1B.

<Operation and Effects of First Embodiment>

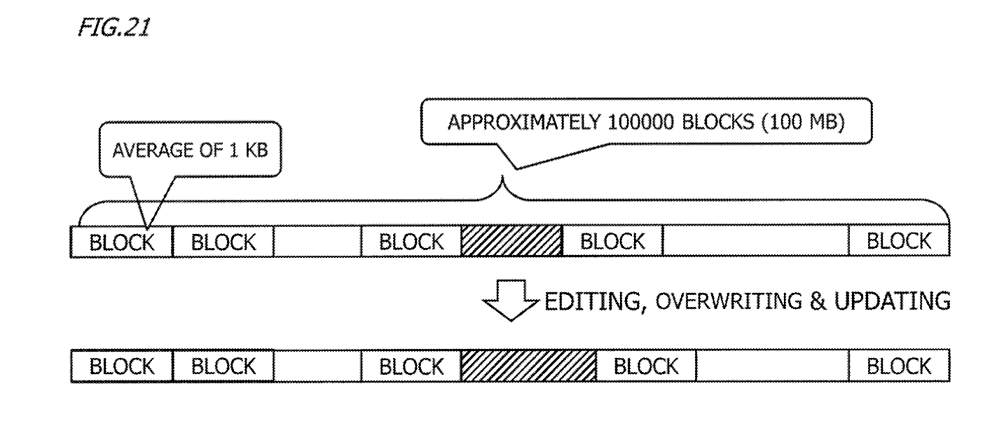

FIG. 21 is a diagram illustrating an example of operation and effects of the first embodiment. FIG. 21 illustrates the case where an intermediate part of a 100 MB file is edited and the resulting file is uploaded to a server.

Chunks (blocks in the figure) have 1 KB in average. The file illustrated in FIG. 21 includes approximately 100000 blocks. It is assumed that from among approximately 100000 blocks, the content of one block located at an intermediate position is changed by editing.

According to the first embodiment, a transmit packet for the file illustrated in FIG. 21 includes two data sections with a flag of 1 (24 bytes) and one data section with a flag of 0 (16 bytes+approximately 1 KB). In other words, since the transmit packet has a size of approximately 1 KB. An amount of forwarded data in the 100 MB file is approximately 1 KB, and thus, a rate of forwarded data reduction is 1/100000, enabling enhancement in rate of forwarded data reduction.

In the first embodiment, the transmission-side deduplication apparatus 1A performs simple memory comparison between data to be transmitted read from the data buffer and data in a file in the cache 118 in units of bytes in order from respective heads. If the data to be transmitted and the data in the file in the cache 118 do not match each other, the transmission-side deduplication apparatus 1A adds information on a position of a matched part preceding the unmatched part in the cache 118 to a transmit packet. Transmission of the information on the position of the matched part in the cache 118 instead of actual data of the matched part enhances a rate of forwarded data reduction.

In the cache 118, a continuous area is secured for an object and chunks are stored successively in order in the area. Accordingly, notification of a position of duplicate data in the cache can be provided as information on the position of the matched part in the cache 118, to the reception-side deduplication apparatus 1B, using a smaller amount of data such as a cache start position and a match length. For example, if chunks are stored in the cache 118 with no association between the chunks and an object ID, even a storage area for the chunks of the same object may be separated by a chunk of another object. If a storage area for chunks of a same object is separated, as information on a position of a matched part in a cache, a cache start position and a match length alone are insufficient for identifying the matched part, resulting in an increase in amount of information on the matched part. Therefore, securing a continuous area for an object in the cache 118 and storing chunks successively in order in the area contributes to enhancement in rate of forwarded data reduction. Also, as a matched part is longer, a rate of forwarded data reduction is higher because no actual data is added to a transmit packet.

Next, the transmission-side deduplication apparatus 1A divides a part of an unmatched part onwards of data to be transmitted into chunks, calculates a hash value for each chunk and searches the hash table 119 for the hash value. If the hash value of the chunk is not included in the hash table 119, the transmission-side deduplication apparatus 1A adds actual data of the chunk to a transmit packet. If the hash value of the chunk is included in the hash table 119, the transmission-side deduplication apparatus 1A resumes simple memory comparison between the data to be transmitted and the data in the file in the cache 118 for data of the relevant chunk onwards.

Since chunks are separated according to positions at which a pattern according to a sectioning condition appears, a chunk length and a hash value of a chunk including an updated part change between before and after the update, but a position at which the pattern according to the sectioning condition appears immediately subsequent to the updated part is merely shifted. Thus, a non-updated chunk subsequent to the updated part does not change in chunk length and hash value between before and after the update and is detected by a search of the hash table 119 using the hash value of the chunk. Accordingly, an end of the updated part, that is, a position at which a match between the data to be transmitted and the data in the file in the cache 118 resumes, can more properly be detected. Consequently, an amount of actual data including the updated part transmitted to the reception-side deduplication apparatus 1B can be reduced to be smaller. Also, processing for dividing the data to be transmitted into chunks and calculating a hash value for each chunk can be reduced to be smaller, enabling reduction in load on the CPU 11 of the transmission-side deduplication apparatus 1A.

Also, in the first embodiment, the transmission-side deduplication apparatus 1A performs simple memory comparison between the data to be transmitted and the data in the file in the cache 118, and if both data fully match each other, and makes a proxy response to the client application 2. In this case, the transmission-side deduplication apparatus 1A transmits no data to the reception-side deduplication apparatus 1B. Therefore, the first embodiment enables reduction in rate of forwarded data.

Also, the transmission-side deduplication apparatus 1A transmits, as information on a position, in the cache 118, of a matched part between the data to be transmitted and the data in the file in the cache 118, a start position in the file including the data to be transmitted, a match length and a cache start position in the cache 118. For example, the position of the matched part may be shifted by an update. In this case, the start position of the matched part in the file including the data to be transmitted, which is data after the update, and a start position of the matched part in the file in the cache 118, which is data before the update may be different from each other. Even in such case, the inclusion of the cache start position as information on the position of the matched part in the cache 118 enables the reception-side deduplication apparatus 1B to read data from the proper position in the file in the cache 128 before the update, with the help of the cache start position.

When a file in a distant file server is overwritten and updated, generally, communications for maintaining the consistency of the file are performed between the client application 2 and the server application 3. However, according to the first embodiment, notification of positions of data before and after an update can properly be provided to the reception-side deduplication apparatus 1B by a transmit packet resulting from deduplication processing, enabling maintenance of the consistency of the file. Therefore, the first embodiment enables omission of communications for maintenance of the consistency of the file at the application level.

The information processing apparatus, the information processing system, the information processing method and the information processing program disclosed enable enhancement in forwarded data amount reduction rate in forwarded data deduplication.

<Recording Medium>

A program for causing a computer or another machine or apparatus (hereinafter, “computer or the like”) to provide any of the above-described functions can be recorded into a recording medium that can be read by a computer or the like. The program in the recording medium is read into the computer or the like and executed, enabling provision of the function.

Here, the recording medium that can be read by the computer or the like refers to a non-temporary recording medium that can store information such as data and/or programs by means of electrical, magnetic, optical, mechanical or chemical action and can be read from the computer or the like. From among such recording mediums, ones that can be removed from the computer or the like include, for example, a flexible disk, a magneto-optical disk, a CD-ROM, a CD-R/W, DVD, a Blu-ray disk, a DAT, an 8 mm tape and a memory card such as a flash memory. Also, recording mediums fixed to the computer or the like include, e.g., a hard disk and a ROM (read-only memory). Furthermore, a SSD (solid state drive) can be used as either a recording medium that can be removed from the computer or the like or a recording medium fixed to the computer or the like.

All examples and conditional language provided herein are intended for the pedagogical purposes of aiding the reader in understanding the invention and the concepts contributed by the inventor to further the art, and are to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a first storage configured to store identification information for a previously-transmitted object and identification information for each of a plurality of data blocks of the previously-transmitted object, the data blocks being separated at respective positions at which a bit string including a predetermined pattern appears, in association with each other;
a second storage configured to stores the identification information for the previously-transmitted object and the plurality of data blocks of the previously-transmitted object in association with each other; and
a processor configured to perform first processing for performing comparison between data in a first object to be transmitted and data in a second object stored in the second storage, the second object matching identification information for the first object to be transmitted, and second processing for sectioning data in the first object to be transmitted off at a position at which the bit string including the predetermined pattern appears to extract a data block from the first object to be transmitted, calculating identification information for the extracted data block and searching the first storage for the identification information for the extracted data block, wherein
the processor is configured to,
when, in the first processing, an unmatched part between the data in the first object to be transmitted and the data in the second object stored in the second storage is detected and there is a matched part preceding the unmatched part, transmit at least information on a position of the matched part in the second object stored in the second storage, and perform the second processing for data at a start position of the unmatched part onwards in the first object to be transmitted, and
when, in the second processing, identification information for the extracted data block is not included in the first storage, transmit the extracted data block, and when identification information for the extracted data block is included in the first storage, perform the first processing for data in the extracted data block onwards in each of the first object to be transmitted and the second object stored in the second storage.

2. The information processing apparatus according to claim 1, wherein:
the second storage is configured to store the plurality of data blocks successively in order in a continuous area secured for the previously-transmitted object; and
in the first processing, when there is a matched part preceding the unmatched part, between the data in the first object to be transmitted and the data in the second object stored in the second storage, the processor is configured to transmit a start position of the matched part in the first object to be transmitted, a length of the matched part, and a start position of the matched part in the second object stored in the second storage.

3. The information processing apparatus according to claim 1, wherein in the first processing, when no unmatched part is detected as a result of the comparison between the data in the first object to be transmitted and the data in the second object stored in the second storage, the processor is configured to make a proxy response to a source apparatus that is a source of the first object to be transmitted.

4. The information processing apparatus according to claim 1, wherein in the second processing, when processing for data at a tail end of the first object to be transmitted ends and the bit string including the predetermined pattern does not appear in the data at the tail end, the processor is configured to transmit actual data included in the first object from data at an end position of a last data block to the data at the tail end.

5. The information processing apparatus according to claim 1, wherein in the second processing, when the identification information for the extracted data block is not included in the first storage, the processor is configured to register the identification information for the extracted data block in the first storage and register the extracted data block in the second storage.

6. An information processing method executed by a computer comprising:
storing identification information for a previously-transmitted object and identification information for each of a plurality of data blocks of the previously-transmitted object, the data blocks being separated at respective positions at which a bit string including a predetermined pattern appears, in association with each other in a first storage;
storing the identification information for the previously-transmitted object and the plurality of data blocks of the previously-transmitted object in association with each other in a second storage;
performing first processing for performing comparison between data in a first object to be transmitted and data in a second object stored in the second storage, the object matching identification information for the first object to be transmitted, and second processing for sectioning data in the first object to be transmitted off at a position at which the bit string including the predetermined pattern appears to extract a data block, calculating identification information for the extracted data block and searching the first storage for the identification information for the extracted data block;
when, in the first processing, an unmatched part between the data in the first object to be transmitted and the data in the second object stored in the second storage is detected and there is a matched part preceding the unmatched part, transmitting at least information on a position of the matched part in the second object stored in the second storage, and performing the second processing for data at a start position of the unmatched part onwards in the first object to be transmitted; and
when, in the second processing, identification information for the extracted data block is not included in the first storage, transmitting the extracted data block, and when identification information for the extracted data block is included in the first storage, performing the first processing for data in the extracted data block onwards in each of the first object to be transmitted and the second object stored in the second storage.

7. A recording medium with an information processing program for causing a computer to:
store identification information for a previously-transmitted object and identification information for each of a plurality of data blocks of the previously-transmitted object, the data blocks being separated at respective positions at which a bit string including a predetermined pattern appears, in association with each other in a first storage;
store the identification information for the previously-transmitted object and the plurality of data blocks of the previously-transmitted object in association with each other in a second storage;
perform first processing for performing comparison between data in a first object to be transmitted and data in a second object stored in the second storage, the object matching identification information for the first object to be transmitted, and second processing for sectioning data in the first object to be transmitted off at a position at which the bit string including the predetermined pattern appears to extract a data block, calculating identification information for the extracted data block and searching the first storage for the identification information for the extracted data block;
when, in the first processing, an unmatched part between the data in the first object to be transmitted and the data in the second object stored in the second storage is detected and there is a matched part preceding the unmatched part, transmit at least information on a position of the matched part in the second object stored in the second storage, and perform the second processing for data at a start position of the unmatched part onwards in the first object to be transmitted; and
when, in the second processing, identification information for the extracted data block is not included in the first storage, transmit the extracted data block, and when identification information for the extracted data block is included in the first storage, perform the first processing for data in the extracted data block onwards in each of the first object to be transmitted and the second object stored in the second storage.
